(19) United States
(12) Patent Application Publication
(10) Pub. No.: US 2026/0099208 A1
(43) Pub. Date: Apr. 9, 2026

(54) METHOD AND SYSTEM FOR PROVIDING A PLATFORM AGNOSTIC MIXED REALITY EXPERIENCE TO USERS

(71) Applicant: FLYING FLAMINGOS INDIA PVT LTD, Bangalore (IN)

(72) Inventors: Kalpit Singh Kushwaha, Jaipur (IN); Amit Gaiki, Bangalore (IN); Shourya Agarwal, Ajmer (IN); Malhar Patil, Nagpur (IN); Divyansh Gupta, Banswara (IN)

(21) Appl. No.: 19/333,831

(22) Filed: Sep. 19, 2025

(30) Foreign Application Priority Data
Sep. 19, 2024 (IN) 202441070765

(51) Int. Cl. G06F 3/01; G06F 3/04883; G06F 9/50; G06T 19/00

(52) U.S. Cl. CPC G06F 3/017; G06F 3/04883; G06F 9/5027; G06T 19/006; G06F 2209/509

(57) ABSTRACT

The present disclosure relates to a method and system for providing a platform agnostic mixed reality experience to users. The method includes determining, by a mixed reality system, activation of a trigger during a real-world view captured by a user device of a user, the trigger being associated with a mixed reality experience identifier (ID). The method also includes providing, by the mixed reality system, access to one or more assets linked to the mixed reality experience ID. The one or more assets are dynamically downloaded to the user device. Further, the method includes rendering, by the mixed reality system, an alpha channel video overlay on the real-world view. Moreover, the method includes enabling, by the mixed reality system, user interaction with the alpha channel video overlay using one of gestures and touch inputs to render a mixed reality experience to the user.

### CROSS-REFERENCE TO RELATED APPLICATIONS

This application claims the benefit of Indian Provisional Application No. 202441070765, filed on Sep. 19, 2024, which is incorporated herein in its entirety.

### FIELD OF THE INVENTION

The present invention generally relates to mixed reality and more particularly to a method and system for providing a platform agnostic mixed reality experience to users.

### BACKGROUND

Development of mixed reality (MR) experiences has seen many advances today. Even though many users do partake in such MR experiences, they do face some challenges still and it is not a hassle-free experience. One such challenge is that there is no seamless integration of MR across multiple platforms, such as Android, iOS, Windows, and web. Traditional methods often lack interoperability and require platform-specific implementations. The users also lose interest in such MR experiences due to a requirement of multiple application downloads. Furthermore, the marketing of content to the users does not reach full potential. Existing solutions are not optimized to leverage dynamic three-dimensional content adaptation and often suffer from latency issues, resource constraints, and security vulnerabilities. Moreover, such solutions fail to provide an adaptive user experience that responds to real-time user interactions and environmental changes.

### SUMMARY OF THE INVENTION

This summary is provided to introduce a selection of concepts in a simplified format that are further described in the detailed description of the invention. This summary is not intended to identify key or essential inventive concepts of the subject matter, nor is it intended for determining the scope of the invention.

A method for providing a platform agnostic mixed reality experience to users includes determining, by a mixed reality system, activation of a trigger during a real-world view captured by a user device of a user, the trigger being associated with a mixed reality experience identifier (ID). The method also includes providing, by the mixed reality system, access to one or more assets linked to the mixed reality experience ID. The one or more assets are dynamically downloaded to the user device. Further, the method includes rendering, by the mixed reality system, an alpha channel video overlay on the real-world view. Moreover, the method includes enabling, by the mixed reality system, user interaction with the alpha channel video overlay using one of gestures and touch inputs to render a mixed reality experience to the user.

A mixed reality system for providing a platform agnostic mixed reality experience to users includes a communication interface in electronic communication with one or more devices and a memory that stores instructions. The mixed reality system further includes a processor responsive to the instructions to determine activation of a trigger during a real-world view captured by a user device of a user. The trigger is associated with a mixed reality experience identifier (ID). The processor is responsive to the instructions to provide access to one or more assets linked to the mixed reality experience ID, wherein the one or more assets are dynamically downloaded to the user device. The processor is responsive to the instructions to render an alpha channel video overlay on the real-world view. Further, the processor is responsive to the instructions to enable user interaction with the alpha channel video overlay using one of gestures and touch inputs to render a mixed reality experience to the user.

A non-transitory computer-readable storage medium having stored thereon, a set of computer-executable instructions causing a computer including one or more processors to perform steps including determining activation of a trigger during a real-world view captured by a user device of a user, the trigger being associated with a mixed reality experience identifier (ID); providing access to one or more assets linked to the mixed reality experience ID, wherein the one or more assets are dynamically downloaded to the user device; rendering an alpha channel video overlay on the real-world view; and enabling user interaction with the alpha channel video overlay using one of gestures and touch inputs to render a mixed reality experience to the user.

To further clarify advantages and features of the present invention, a more particular description of the invention will be rendered by reference to specific embodiments thereof, which is illustrated in the appended figures. It is appreciated that these figures depict only typical embodiments of the invention and are therefore not to be considered limiting of its scope. The invention will be described and explained with additional specificity and detail with the accompanying figures.

### BRIEF DESCRIPTION OF THE DRAWINGS

The invention will be described and explained with additional specificity and detail with the accompanying figures in which:

FIG. 1 is an example representation of an environment, in accordance with an embodiment;

FIG. 2 is an example representation of a mixed reality system, in accordance with an embodiment;

FIG. 3 is an example representation of a mixed reality unit, in accordance with an embodiment;

FIG. 4 illustrates a flow diagram of an exemplary method of providing a platform agnostic mixed reality experience to users, in accordance with an embodiment;

FIG. 5 illustrates a block diagram of an electronic device, in accordance with one embodiment.

Further, skilled artisans will appreciate that elements in the figures are illustrated for simplicity and may not have been necessarily been drawn to scale. Furthermore, in terms of the construction of the device, one or more components of the device may have been represented in the figures by conventional symbols, and the figures may show only those specific details that are pertinent to understanding the embodiments of the present invention so as not to obscure the figures with details that will be readily apparent to those of ordinary skill in the art having benefit of the description herein.

### DETAILED DESCRIPTION

For the purpose of promoting an understanding of the principles of the invention, reference will now be made to the embodiment illustrated in the figures and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components. Appearances of the phrase “in an embodiment”, “in another embodiment” and similar language throughout this specification may, but do not necessarily, all refer to the same embodiment.

Unless otherwise defined, all technical and scientific terms used herein have the same meaning as commonly understood by one of ordinary skill in the art to which this invention belongs. The system, methods, and examples provided herein are illustrative only and not intended to be limiting.

Embodiments of the present invention will be described below in detail with reference to the accompanying figures.

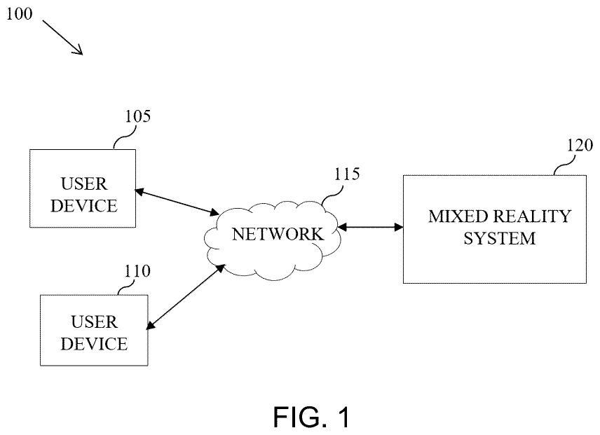

FIG. 1 is an example representation of an environment 100, in accordance with an embodiment. The environment 100 includes a plurality of user devices, for example a user device 105 and a user device 110, a network 115, and a mixed reality system 120. The mixed reality system 120 communicates with the user device 105 and the user device 110. In some embodiments, the mixed reality system 120 is a server. The user device 105 and the user device 110 can communicate with the mixed reality system 120 through the network 115. Examples of the user device 105 and the user device 110 include, but are not limited to, computers, mobile devices, tablets, laptops, palmtops, handheld devices, telecommunication devices, personal digital assistants (PDAs), and the like. Examples of the network 115 include, but are not limited to, a Local Area Network (LAN), a Wireless Local Area Network (WLAN), a Wide Area Network (WAN), internet, a Small Area Network (SAN), and the like.

The mixed reality system 120 is platform-agnostic which means that the mixed reality system 120 is designed to work seamlessly across multiple platforms.

A user of the user device 105 accesses the mixed reality system 120, for example, by scanning a quick-response (QR) code or clicking a hyperlink on a platform, an application or website. Once, the user accesses the mixed reality system 120, an instant mixed reality application, for example hosted on the user device 105, interprets such a trigger and adjusts a user experience based on an operating system or web associated with the user device 105, ensuring a consistent user experience. The instant mixed reality application further downloads assets, and renders a mixed reality experience to the user.

The instant mixed reality application, also referred to as a sandbox, is designed to function uniformly across multiple operating systems, including Android, iOS, Windows, and web platforms. An alpha channel overlay allows a transparent video to be superimposed on a real-world view captured by a camera of the user device 105. The alpha channel overlay can be used to add virtual elements to an environment or enhance existing features. The user can interact with the alpha channel overlay using gestures or touch inputs. Such user interactions can trigger events within the instant mixed reality application, for example starting a video from a specific time point, changing content of the alpha channel overlay, or triggering other interactive elements.

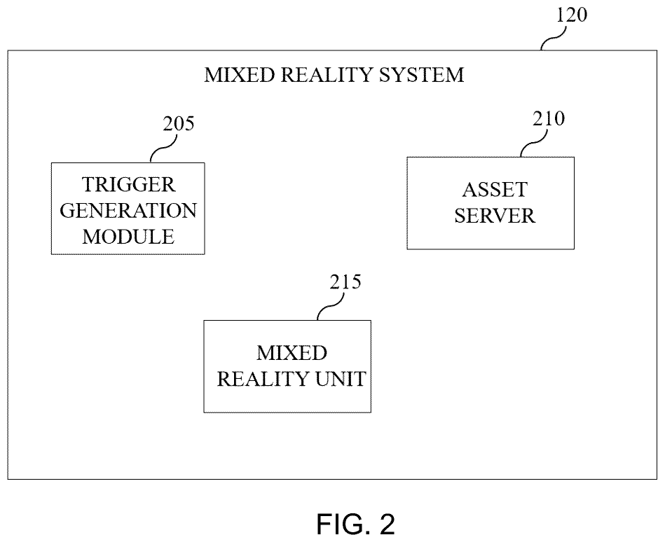

The mixed reality system 120 is explained in detail in FIG. 2.

FIG. 2 is an example representation of the mixed reality system 120, in accordance with an embodiment. The mixed reality system 120 can include a trigger generation module 205, an asset server 210, and a mixed reality unit 215. In some embodiments, the asset server 210 is located external to the mixed reality system 120.

The trigger generation module 205 generates triggers, also referred to as platform-agnostic links that can be embedded in QR codes, near field communication (NFC) tags, or hyperlinks, sent through messaging platforms. The platform-agnostic links include metadata, including a mixed reality experience identifier (ID) for the mixed reality experience, a location of the assets, and parameters influencing the mixed reality experience.

A trigger is a unique link associated with the mixed reality experience ID. When the trigger is activated, for example by scanning the QR code or clicking the hyperlink, the instant mixed reality application or sandbox retrieves the mixed reality experience ID, downloads corresponding assets from the asset server 210, and launches the mixed reality experience for the user.

The trigger generation module 205 creates universal links compatible with any device, regardless of an operating system. The trigger generation module 205 generates uniform resource locators (URLs) or uniform resource identifiers (URIs) adhering to standard web protocols, ensuring compatibility across Android, iOS, Windows, and web browsers.

In one example, a museum uses the trigger generation module 205 to create QR codes placed next to exhibits. Visitors scan the QR codes to instantly access mixed reality experiences related to each exhibit without installing any applications.

The asset server 210 hosts the assets required for the mixed reality experience. Examples of the assets include, but are not limited to, videos, three-dimensional (3D) models, and scripts. The assets are downloaded upon activation of the trigger.

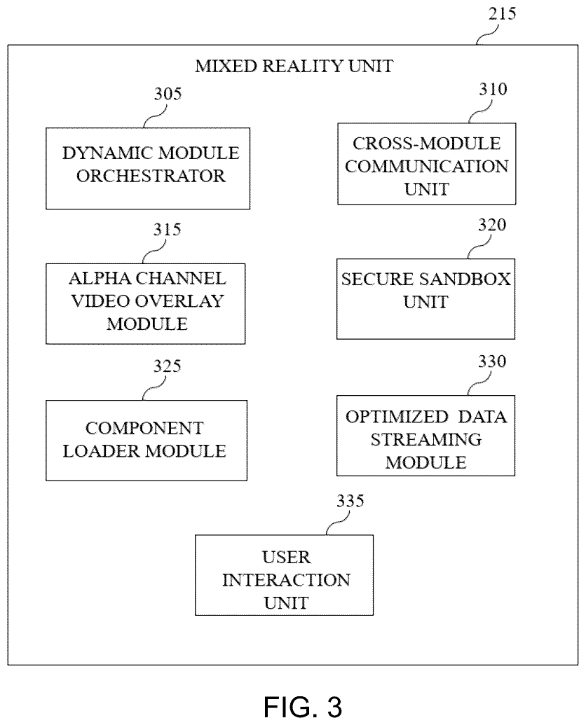

In some embodiments, the mixed reality system 120 can include the mixed reality unit 215. The mixed reality unit 215 is further explained in detail in FIG. 3. As illustrated in FIG. 3, the mixed reality unit 215 further includes a dynamic module orchestrator 305, a cross-module communication unit 310, an alpha channel video overlay module 315, a secure sandbox unit 320, a component loader module 325, an optimized data streaming module 330, and a user interaction unit 335.

The dynamic module orchestrator 305 performs loading and unloading of one or more mixed reality modules in real-time based on a plurality of user interactions and environmental data. A mixed reality module is a set of assets. The mixed reality modules run in a kernel-level application sandbox in a Linux-based system. The dynamic module orchestrator 305 ensures that appropriate modules are loaded as needed to optimize performance and user experience.

The dynamic module orchestrator 305 receives user interaction data, environmental context, and device resource availability, as input. The dynamic module orchestrator 305 monitors the input by collecting data from user interactions and environmental sensors, and analyses module requirements by determining necessary MR modules based on current context. The dynamic module orchestrator 305 performs resource assessment by evaluating device resources to ensure capacity for module execution, and dynamically loads required MR modules into the kernel-level sandbox and unloads unnecessary MR modules. The dynamic module orchestrator 305 also continuously adapts to changing conditions. The dynamic module orchestrator 305 generates an optimized set of active MR modules, as output, thereby delivering a seamless MR experience.

In an example, in a city navigation MR application, when the user points the user device at a landmark, the MR system dynamically loads the MR module responsible for overlaying historical information. As the user moves away, this particular MR module is unloaded, and another MR module for general navigation is loaded instead.

The cross-module communication unit 310 facilitates real-time data exchange between different MR modules to ensure seamless interaction between two-dimensional (2D) alpha content and three-dimensional (3D) environment mapping. The cross-module communication unit 310 enables the MR modules to communicate so that virtual elements (for example, 2D overlays) are accurately positioned and synchronized with a 3D environment. The cross-module communication unit 310 further enables the MR modules to publish and subscribe to events, allowing for decoupled yet coordinated operation. The cross-module communication unit 310 also prevents external interference and maintains system integrity as communication occurs within the sandbox.

In one example, in an MR game, when a user interacts with a 2D alpha channel overlay (for example, a virtual button), the input is communicated to a 3D rendering module, which then updates a game environment accordingly.

The alpha channel video overlay module 315 allows a transparent video to be superimposed on the real-world view captured by a camera of the user device. The overlay can be used to add virtual elements to the environment or to enhance existing features. The alpha channel video overlay module 315 enables transparency support by utilizing videos with an alpha channel to render transparent or semi-transparent overlays. The alpha channel video overlay module 315 enables real-time rendering as overlays are rendered in real-time, adjusting to the camera perspective and the camera movement. The alpha channel video overlay module 315 enables virtual element integration as the overlays can represent virtual objects, characters, or informational content, seamlessly blending with the real world.

In an example, in an MR shopping application, the user can see how a piece of furniture would look in their room by viewing a transparent 3D model overlaid on their camera feed. In another example, the user can view an MR experience for any advertisement in a newspaper.

Users can interact with the alpha channel video overlay using gestures or touch inputs. These interactions can trigger events within the application, such as starting a video from a specific time point, changing overlay content, or triggering other interactive elements. The alpha channel video overlay module 315 recognizes the gestures such as swipes, taps, and pinches to interact with virtual elements. The alpha channel video overlay module 315 allows direct manipulation of the overlays through touch-screen interfaces. The alpha channel video overlay module 315 also recognizes interactions that can start videos from specific timestamps, change overlay content, or activate other interactive elements.

In an example, in a mixed reality based newspaper advertisement application, a user taps on a transparent overlay of a product figure, triggering a video that provides more information about them. Swiping left or right could switch between different figures or topics, or tapping on a certain region switches a whole video context.

The mixed reality system 120 operates in a secure sandbox environment using the secure sandbox unit 320 that enables context-aware permission management and a secure execution framework. The secure sandbox environment allows management of permissions dynamically, grants or revokes access to device resources (for example, camera, sensors) based on a current context of the mixed reality application. The secure sandbox environment further provides a secure isolated environment for executing the mixed reality modules, protecting the mixed reality system 120 from security threats and ensuring that each module operates without interference. This prevents malicious or faulty modules from affecting device stability or accessing unauthorized data. The sandbox uses virtualization or containerization techniques for isolation. In an example, a downloaded MR module cannot access the device's file system or personal data unless explicitly permitted, ensuring user privacy and security. The secure sandbox environment can be achieved using mandatory access control (MAC) to specify permissions based on module roles and context. In an example, a module requiring camera access is granted permission only when active and necessary, preventing unauthorized use.

The mixed reality unit 215 also includes the component loader module 325. The component loader module 325 uses machine learning algorithms to anticipate which mixed reality components will be needed next, preloading them to reduce latency and enhance responsiveness. The component loader module 325 continuously monitors device resources and adjusts fidelity of the mixed reality modules to maintain smooth performance, particularly during complex scenes involving alpha channel content. The component loader module 325 further makes use of 3D streaming for 3D components and 2D video streaming for smooth performance.

The component loader module 325 receives historical user interaction data, current session data, and environmental context as input. The component loader module 325 collects data, for example the user interaction data and the environmental data and trains models (for example, neural networks) on the data. The component loader module 325 forecasts likely next actions and identifies and preload associated MR components or MR modules.

In an example, in a gaming MR application, if users typically open a map after reaching a checkpoint, the component loader module 325 preloads a map module when a checkpoint is approached. Similar approach is not limited to a newspaper advertisement, image or QR code trigger-based application.

Further, the device resources (for example, CPU, memory, battery) are monitored, and fidelity of the MR modules is adjusted to ensure smooth performance. The MR system 120 employs 3D and 2D streaming methods, adjusting quality based on resource availability. In one example on a device with limited memory, the system may reduce texture resolutions or simplify models to maintain performance.

The optimized data streaming module 330 uses an adaptive data streaming protocol which optimizes streaming of mixed reality data based on network conditions, ensuring that two-dimensional alpha channel videos and images are delivered with minimal latency. It employs adaptive bitrate streaming, ensuring minimal latency for alpha channel videos and 3D models. The optimized data streaming module 330 enables 3D streaming and device performance-based optimization (currently defined by device hardware specs and run time resources). The optimized data streaming module 330 further enables edge computing integration in which intensive data processing tasks are offloaded to edge applications, reducing load on devices and improving overall user experience. In an example, complex physics simulations for an MR training application are processed on edge devices or locally on a phone, with results streamed to the user's device. The optimized data streaming module 330 further enables network monitoring for real-time bandwidth and latency, dynamically adjusts asset quality, and uses caching to prevent interruptions. In an example, during a network slowdown, the system reduced a quality of streamed assets to maintain a smooth experience.

The mixed reality unit 215 includes the user interaction unit 335. The user interaction unit 335 operates on an adaptive user interface framework which dynamically adjusts user interface based on the user interactions and environmental changes to provide an intuitive and immersive mixed reality experience. The user interaction unit 335 provides a responsive design for different devices, provides contextual controls to appear when relevant, and provides support for touch, gestures, and voice input. For example, in a navigation application, user interface elements adjust based on whether the user is walking or driving.

The mixed reality unit 215 also uses haptic feedback integration that adds tactile, vibrations and lightning feedback to interactions with the two-dimensional alpha content to enhance sense of realism and user engagement. For instance, in an MR shopping application, when a user selects a virtual product, a vibration simulates the sensation of picking up an item.

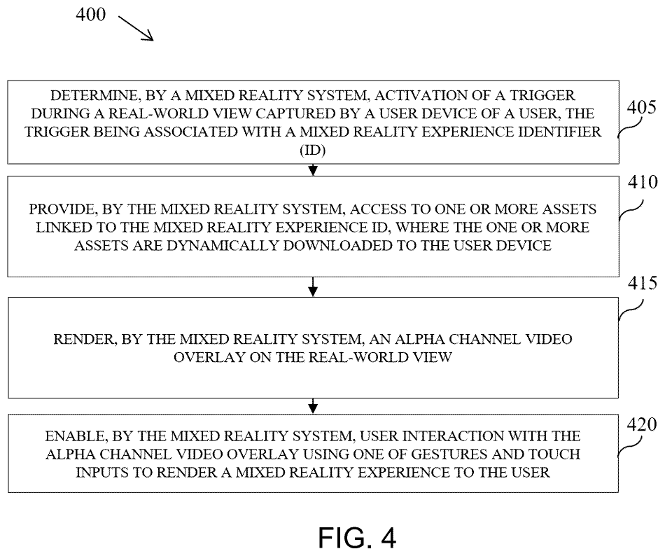

An example method of providing the platform agnostic mixed reality experience to the user is explained below with reference to FIG. 4.

Referring to FIG. 4, at step 405, the method 400 includes determining, by a mixed reality system, for example the mixed reality system 120 of FIG. 1, activation of a trigger during a real-world view captured by a user device of a user. The trigger is associated with a mixed reality (MR) experience identifier (ID) and can be one of a quick response (QR) code, a near field communication (NFC) tag, and a hyperlink. In some embodiments, the trigger is activated when a user scans the QR code or clicks the hyperlink using a user device, for example the user device 105 of FIG. 1. The MR experience ID is further extracted based on activation of the trigger. The activation of the trigger is explained in detail with reference to FIG. 2 and FIG. 3.

At step 410, the method 400 further includes, providing, by the mixed reality system, access to one or more assets linked to the mixed reality experience ID. The assets can be dynamically downloaded to the user device. The assets are loaded and starts an MR experience for the user.

At step 415, the method 400 includes, rendering, by the mixed reality system, an alpha channel video overlay on a real-world view. The alpha channel video overlay can be used to add virtual elements to an environment or enhance existing features.

At step 420, the method 400 includes, enabling, by the mixed reality system, user interaction with the alpha channel video overlay using one of gestures or touch inputs to render a mixed reality experience to the user. Such user interaction can trigger events within a mixed reality application, for example starting a video from a specific time point, changing content of the alpha channel overlay, or triggering other interactive elements.

In some embodiments, the method 400 allows for adaptive 3D content rendering in which device sensors collect accelerometer and gyroscope data, predictive component loader identifies and loads relevant 3D components, user interactions are monitored, feeding into a feedback loop, and content rendering is optimized dynamically based on feedback. FIG. 2 and FIG. 3 can be referred to for detailed explanation of above method steps.

The method 400 can further be explained with some examples. In one example, when a user named Amit sees a car advertisement in the newspaper, he scans a QR code that he views on the car advertisement. On trigger activation, the QR code launches the MR experience instantly and no app installation is required. During the MR experience initialization, the MR experience ID is retrieved for the car model, and assets like 3D models and textures are loaded. MR modules for exterior rendering, interior exploration, and interactive features are loaded based on Amit's interactions. Unnecessary modules are unloaded to optimize performance. Interaction with 2D overlays (for example, selecting a car colour) communicates with 3D rendering modules to update the car's appearance. Transparent overlays display additional information, such as specifications. Amit taps on an overlay to start a video highlighting safety features. As Amit moves around the car advertisement, accelerometer and gyroscope data adjust the 3D model to match his perspective. Haptic feedback simulates the feel of opening doors behaviour or adjusting controls. Interior features could be preloaded and pop up as Amit approaches the driver's seat. Adaptive user interface presents options like customizing features or scheduling a test drive. The data streamer adjusts quality based on Amit's network and edge computing handles rendering complex details, thereby ensuring a smooth experience.

In another example, when a user named Shourya walks into a furniture store and sees a sofa he likes, he scans a QR code on the price tag, which launches an MR experience on his phone. The MR system loads the MR modules for texture mapping and colour adjustments and unloads unnecessary modules to conserve resources. The user interactions with 2D overlays communicate with 3D rendering modules to update the sofa's appearance. Transparent overlays allow Shourya to select different fabric options. Tapping on overlays changes the sofa's material in real-time. Anticipating that Shourya might want to see matching furniture, the MR system preloads the MR modules for coffee tables and rugs. High-resolution textures are streamed as Shourya focuses on specific details. The MR system adjusts quality based on Shourya's network conditions. Further, complex rendering tasks are handled by edge or mobile devices, allowing Shourya's phone to run the MR experience smoothly.

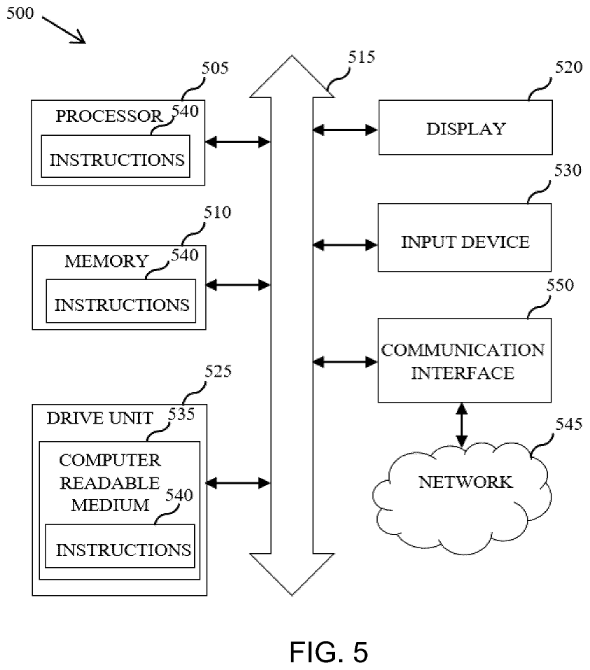

FIG. 5 illustrates a block diagram of an electronic device 500, which is representative of a hardware environment for practicing the present invention. The electronic device 500 can include a set of instructions that can be executed to cause the electronic device 500 to perform any one or more of the methods disclosed. The electronic device 500 may operate as a standalone device or can be connected, for example using a network, to other electronic devices or peripheral devices.

In a networked deployment of the present invention, the electronic device 500 may operate in the capacity of a mobile device, for example the user device 105, the user device 110, or the mixed reality system 120 of FIG. 1, in a server-client user network environment. The electronic device 500 can also be implemented as or incorporated into various devices, such as a personal computer (PC), a tablet PC, a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. Further, while a single electronic device 500 is illustrated, the term “device” shall also be taken to include any collection of systems or sub-systems that individually or jointly execute a set, or multiple sets, of instructions to perform one or more computer functions.

The electronic device 500 can include a processor 505, for example a central processing unit (CPU), a graphics processing unit (GPU), or both. The processor 505 can be a component in a variety of systems. For example, the processor 505 can be part of a standard personal computer or a workstation. The processor 505 can be one or more general processors, digital signal processors, application specific integrated circuits, field programmable gate arrays, servers, networks, digital circuits, analog circuits, combinations thereof, or other now known or later developed devices for analyzing and processing data. The processor 505 can implement a software program, such as code generated manually (for example, programmed).

The electronic device 500 can include a memory 510, such as a memory 510 that can communicate via a bus 515. The memory 510 can include a main memory, a static memory, or a dynamic memory. The memory 510 can include, but is not limited to, computer readable storage media such as various types of volatile and non-volatile storage media, including but not limited to, random access memory, read-only memory, programmable read-only memory, electrically programmable read-only memory, electrically erasable read-only memory, flash memory, magnetic tape or disk, optical media and the like. In one example, the memory 510 includes a cache or random access memory for the processor 505. In alternative examples, the memory 510 is separate from the processor 505, such as a cache memory of a processor, the system memory, or other memory. The memory 510 can be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 510 is operable to store instructions executable by the processor 505. The functions, acts or tasks illustrated in the figures or described can be performed by the programmed processor 505 executing the instructions stored in the memory 510. The functions, acts or tasks are independent of the particular type of instructions set, storage media, processor or processing strategy and can be performed by software, hardware, integrated circuits, firm-ware, micro-code and the like, operating alone or in combination. Likewise, processing strategies can include multiprocessing, multitasking, parallel processing and the like.

As shown, the electronic device 500 can further include a display unit 520, for example a liquid crystal display (LCD), an organic light emitting diode (OLED), a flat panel display, a solid state display, a cathode ray tube (CRT), a projector, a printer or other now known or later developed display device for outputting determined information. The display 520 can act as an interface for a user to see the functioning of the processor 505, or specifically as an interface with the software stored in the memory 510 or in a drive unit 525.

Additionally, the electronic device 500 can include an input device 530 configured to allow the user to interact with any of the components of the electronic device 500. The input device 530 can include a stylus, a number pad, a keyboard, or a cursor control device, for example a mouse, or a joystick, touch screen display, remote control or any other device operative to interact with the electronic device 500.

The electronic device 500 can also include the drive unit 525. The drive unit 525 can include a computer-readable medium 535 in which one or more sets of instructions 540, for example software, can be embedded. Further, the instructions 540 can embody one or more of the methods or logic as described. In a particular example, the instructions 540 can reside completely, or at least partially, within the memory 510 or within the processor 505 during execution by the electronic device 500. The memory 510 and the processor 505 can also include computer-readable media as discussed above.

The present invention contemplates a computer-readable medium that includes instructions 540 or receives and executes the instructions 540 responsive to a propagated signal so that a device connected to a network 545 can communicate voice, video, audio, images or any other data over the network 545. Further, the instructions 545 can be transmitted or received over the network 545 via a communication port or communication interface 550 or using the bus 515. The communication interface 550 can be a part of the processor 505 or can be a separate component. The communication interface 550 can be created in software or can be a physical connection in hardware. The communication interface 550 can be configured to connect with the network 545, external media, the display 520, or any other components in the electronic device 500 or combinations thereof. The connection with the network 545 can be a physical connection, such as a wired Ethernet connection or can be established wirelessly as discussed later. Likewise, the additional connections with other components of the electronic device 500 can be physical connections or can be established wirelessly. The network 545 can alternatively be directly connected to the bus 515.

The network 545 can include wired networks, wireless networks, Ethernet AVB networks, or combinations thereof. The wireless network can include a cellular telephone network, an 802.11, 802.16, 802.20, 802.1Q or WiMax network. Further, the network 545 can be a public network, such as the Internet, a private network, such as an intranet, or combinations thereof, and can utilize a variety of networking protocols now available or later developed including, but not limited to TCP/IP based networking protocols.

In an alternative example, dedicated hardware implementations, such as application specific integrated circuits, programmable logic arrays and other hardware devices, can be constructed to implement various parts of the electronic device 500.

One or more examples described can implement functions using two or more specific interconnected hardware modules or devices with related control and data signals that can be communicated between and through modules, or as portions of an application-specific integrated circuit. Accordingly, the present system encompasses software, firmware, and hardware implementations.

The system described can be implemented by software programs executable by an electronic device. Further, in a non-limited example, implementations can include distributed processing, component/object distributed processing, and parallel processing. Alternatively, virtual electronic device processing can be constructed to implement various parts of the system.

The system is not limited to operation with any particular standards and protocols. For example, standards for Internet and other packet switched network transmission (for example, TCP/IP, UDP/IP, HTML, HTTP) can be used. Such standards are periodically superseded by faster or more efficient equivalents having essentially the same functions. Accordingly, replacement standards and protocols having the same or similar functions as those disclosed are considered equivalents thereof.

Various embodiments disclosed herein provide numerous advantages by providing a method and system for providing a platform-agnostic mixed reality experience to users. This present disclosure enables a seamless MR experience that is independent of the operating system, providing a consistent user experience across various devices and platforms. The present disclosure allows creators to create and publish mixed reality content for their users. The present disclosure allows the users to consume or interact directly with mixed reality content without application downloads. Further, the present disclosure makes user acquisition easier for content creators and view rates for content using this system is of a high magnitude.

The present disclosure utilizes real-time adaptation of 3D content, harnesses device sensors such as the accelerometer and gyroscope, and optimizes the data delivery process through size reduction techniques and edge computing integration. The inclusion of a feedback loop for real-time optimization significantly enhances the user experience. The present disclosure has broad applications across industries such as advertisements, education, retail, gaming, and tourism, offering users enriched interactions with their environment and content in a seamless, intuitive manner.

While specific language has been used to describe the disclosure, any limitations arising on account of the same are not intended. As would be apparent to a person in the art, various working modifications may be made to the method in order to implement the inventive concept as taught herein.

The figures and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

The claimed invention is:

1. A method of providing a platform agnostic mixed reality experience to users, the method comprising:
determining, by a mixed reality system, activation of a trigger during a real-world view captured by a user device of a user, the trigger being associated with a mixed reality experience identifier (ID);
providing, by the mixed reality system, access to one or more assets linked to the mixed reality experience ID, wherein the one or more assets are dynamically downloaded to the user device;
rendering, by the mixed reality system, an alpha channel video overlay on the real-world view; and
enabling, by the mixed reality system, user interaction with the alpha channel video overlay using one of gestures and touch inputs to render a mixed reality experience to the user.

2. The method as claimed in claim 1, wherein the trigger comprises one of a quick response (QR) code, a near field communication (NFC) tag, and a hyperlink.

3. The method as claimed in claim 1, wherein providing the access to the one or more assets linked to the mixed reality experience ID further comprises:
orchestrating, by the mixed reality system, loading and unloading of one or more mixed reality modules in real-time based on a plurality of user interactions and environmental data;
executing, by the mixed reality system, the one or more mixed reality modules within a kernel-level application sandbox in a Linux-based system; and
facilitating, by the mixed reality system, seamless cross-module communication between the one or more mixed reality modules to enable interaction between two-dimensional alpha content and three-dimensional environment mapping.

4. The method as claimed in claim 3, wherein rendering the alpha channel video overlay on the real-world view further comprises:
rendering, by the mixed reality system, one or more transparent videos with alpha channels superimposed on the real-world view; and
adjusting, by the mixed reality system, the alpha channel video overlay in real-time based on camera perspective and camera movement to integrate virtual elements with a physical environment.

5. The method as claimed in claim 4, wherein enabling the user interaction with the alpha channel video overlay using one of gestures and touch inputs further comprises:
triggering, by the mixed reality system, one or more events within a mixed reality application based on the plurality of user interactions, wherein the one or more events comprise one or more of starting videos from specific time points, changing overlay content, and activating interactive elements.

6. The method as claimed in claim 5 and further comprising:
utilizing, by the mixed reality system, machine learning algorithms to predictively preload one or more mixed reality modules based on a historical user interaction data and a current environmental context; and
reducing, by the mixed reality system, latency and enhancing responsiveness by preloading the one or more mixed reality modules.

7. The method as claimed in claim 6 and further comprising:
monitoring, by the mixed reality system, network conditions and device performance metrics in real-time;
adjusting, by the mixed reality system, one or more data streaming parameters based on available bandwidth and latency, wherein the one or more data streaming parameters comprise quality and rate;
implementing, by the mixed reality system, buffering and caching methods to ensure a seamless mixed reality experience; and
integrating, by the mixed reality system, edge computing to offload intensive processing tasks to reduce device load.

8. The method as claimed in claim 7 and further comprising:
collecting, by the mixed reality system, sensor data from one or more device sensors of the user device, wherein the one or more device sensors include accelerometers and gyroscopes;
adjusting, by the mixed reality system, a rendering of three-dimensional content in real-time based on the sensor data to match the camera perspective and the camera movement; and
implementing, by the mixed reality system, a feedback loop to optimize content delivery and the user interaction.

9. A mixed reality system for providing a platform agnostic mixed reality experience to users, the mixed reality system comprising:
a communication interface in electronic communication with one or more devices;
a memory that stores instructions; and
a processor responsive to the instructions to:
determine activation of a trigger during a real-world view captured by a user device of a user, the trigger being associated with a mixed reality experience identifier (ID);
provide access to one or more assets linked to the mixed reality experience ID, wherein the one or more assets are dynamically downloaded to the user device;
render an alpha channel video overlay on the real-world view; and
enable user interaction with the alpha channel video overlay using one of gestures and touch inputs to render a mixed reality experience to the user.

10. The mixed reality system as claimed in claim 9, wherein the trigger comprises one of a quick response (QR) code, a near field communication (NFC) tag, and a hyperlink.

11. The mixed reality system as claimed in claim 9, wherein the processor is further responsive to the instructions to provide the access to the one or more assets linked to the mixed reality experience ID by:
orchestrating loading and unloading of one or more mixed reality modules in real-time based on a plurality of user interactions and environmental data;
executing the one or more mixed reality modules within a kernel-level application sandbox in a Linux-based system; and
facilitating seamless cross-module communication between the one or more mixed reality modules to enable interaction between two-dimensional alpha content and three-dimensional environment mapping.

12. The mixed reality system as claimed in claim 11, wherein the processor is further responsive to the instructions to render the alpha channel video overlay on the real-world view by:
rendering one or more transparent videos with alpha channels superimposed on the real-world view; and
adjusting the alpha channel video overlay in real-time based on camera perspective and camera movement to integrate virtual elements with a physical environment.

13. The mixed reality system as claimed in claim 12, wherein the processor is further responsive to the instructions to enable the user interaction with the alpha channel video overlay by:
triggering one or more events within a mixed reality application based on the plurality of user interactions, wherein the one or more events comprise one or more of starting videos from specific time points, changing overlay content, and activating interactive elements.

14. The mixed reality system as claimed in claim 13, wherein the processor is further responsive to the instructions to:
utilize machine learning algorithms to predictively preload one or more mixed reality modules based on a historical user interaction data and a current environmental context; and
reduce latency and enhancing responsiveness by preloading the one or more mixed reality modules.

15. The mixed reality system as claimed in claim 14, wherein the processor is further responsive to the instructions to:
monitor network conditions and device performance metrics in real-time;
adjust one or more data streaming parameters based on available bandwidth and latency, wherein the one or more data streaming parameters comprise quality and rate;
implement buffering and caching methods to ensure a seamless mixed reality experience; and
integrate edge computing to offload intensive processing tasks to reduce device load.

16. The mixed reality system as claimed in claim 15, wherein the processor is further responsive to the instructions to:
collect sensor data from one or more device sensors of the user device, wherein the one or more device sensors include accelerometers and gyroscopes;
adjust a rendering of three-dimensional content in real-time based on the sensor data to match the camera perspective and the camera movement; and
implement a feedback loop to optimize content delivery and the user interaction.

17. A non-transitory computer-readable storage medium having stored thereon, a set of computer-executable instructions causing a computer comprising one or more processors to perform steps comprising:
determining activation of a trigger during a real-world view captured by a user device of a user, the trigger being associated with a mixed reality experience identifier (ID);
providing access to one or more assets linked to the mixed reality experience ID, wherein the one or more assets are dynamically downloaded to the user device;
rendering an alpha channel video overlay on the real-world view; and
enabling user interaction with the alpha channel video overlay using one of gestures and touch inputs to render a mixed reality experience to the user.
